(19) United States
(12) Patent Application Publication
(10) Pub. No.: US 2017/0355041 A1
(43) Pub. Date: Dec. 14, 2017

(54) METHOD FOR PROCESSING SiC MATERIAL

(71) Applicant: EL-SEED CORPORATION, Nagoya-shi (JP)

(72) Inventors: Kenji YAMASHITA, Nagoya-shi, Aichi (JP); Koichi NANIWAE, Nagoya-shi, Aichi (JP)

(21) Appl. No.: 15/539,708

(22) PCT Filed: Nov. 16, 2015
(86) PCT No.: PCT/JP2015/082171

§ 371 Date: Jun. 26, 2017

(30) Foreign Application Priority Data
Dec. 26, 2014 (JP) 2014-264140

(51) Int. Cl. B23K 26/00; B23K 26/08; B23K 26/06; B23K 101/40

(52) U.S. Cl. CPC B23K 26/0057; B23K 26/0608; B23K 26/0853; B23K 26/0626; B23K 26/0617; B23K 26/0093; B23K 2201/40

(57) ABSTRACT

For allowing a crack to progress between respective lines reliably while shortening a laser beam irradiation time, a method for processing SiC material includes allowing a laser beam to be absorbed in a cutting scheduled plane of an SiC material to form an altered pattern including a plurality of line-shaped altered regions; and cutting the SiC material along the cutting scheduled plane, wherein a plurality of line-shaped main altered regions extending in a predetermined direction, arranged at a first pitch P1 and included in altered region groups is formed, and a plurality of altered region groups is arranged at a second pitch P2 larger than the first pitch P1.

### TECHNICAL FIELD

The present invention relates to a method for processing SiC material.

### BACKGROUND ART

SiC materials are generally cut mechanically using a wire saw or the like. However, since SiC has high hardness, processing using a wire saw or the like has a problem that the processing is performed at a low speed and the throughput decreases.

In order to eliminate this problem, a SiC material cutting method in which a pulsed laser beam is irradiated along a cutting scheduled plane of a SiC material to form a altered region inside the SiC material and the SiC material is cut along the cutting scheduled plane is proposed (see Patent Document 1). In the method disclosed in Patent Document 1, the laser beam is moved in relation to the SiC material along a predetermined line in a state in which a focusing point is aligned on the cutting scheduled plane inside the SiC material. In Patent Document 1, it is described that a c-plane crack from the altered region is generated ideally when a pitch between one irradiation point of the laser beam and another irradiation point closes to the irradiation point is equal to or larger than 1 μm and smaller than 10 μm.

### CITATION LIST

### Patent Document

Patent Document 1: Japanese Patent Application Publication No. 2013-49161

### SUMMARY OF THE INVENTION

### Problems to be Solved by the Invention

However, when line-shaped altered regions are formed at equal intervals as illustrated in Patent Document 1, if the interval between respective lines exceeds a predetermined pitch, a crack does not progress between the respective lines. The pitch between respective lines may be set to be equal to or smaller than 10 μm as disclosed in Patent Document 1 in order to allow a crack to progress between respective lines reliably. However, in this case, it takes a considerable time to irradiate a laser beam to the cutting scheduled plane and the throughput decreases.

The present invention has been made in view of the above-described problem, and an object thereof is to provide a method for processing SiC material capable of allowing a crack to progress between respective lines reliably while shortening a laser beam irradiation time.

### Solutions to Problems

In order to attain the object, the present invention provides a method for processing SiC material, including: allowing a laser beam to be absorbed in a cutting scheduled plane of an SiC material to form an altered pattern including a plurality of line-shaped altered regions; and cutting the SiC material along the cutting scheduled plane, wherein the altered pattern has altered region groups including a plurality of line-shaped main altered regions extending in a predetermined direction and arranged at a first pitch, and a plurality of altered region groups is arranged at a second pitch larger than the first pitch.

In the method for processing SiC material, the altered pattern may include a plurality of line-shaped auxiliary altered regions extending in a different direction from the predetermined direction, and the auxiliary altered region may be formed so as to cross at least adjacent two altered region groups.

In the method for processing SiC material, the respective auxiliary altered regions may extend in a direction approximately orthogonal to the altered region group, wherein the respective auxiliary altered regions extend in a direction approximately orthogonal to the altered region group.

In the method for processing SiC material, the number of main altered regions included in one altered region group may be equal to or larger than 2 and equal to smaller than 10.

In the method for processing SiC material, the first pitch may be equal to or larger than 1.0 μm and smaller than 50 μm, and the second pitch may be equal to or larger than 50 μm and equal to smaller than 500 μm.

The present invention also provides a method fix processing SiC material including: allowing a laser beam to be absorbed in a cutting scheduled plane of an SiC material to form an altered pattern including a plurality of line-shaped altered regions; and cutting the SiC material along the cutting scheduled plane, wherein the altered pattern has a plurality of line-shaped main altered regions extending in a predetermined direction, and pitches between the respective main altered regions include at least two pitches.

### Effects of the Invention

According to the method for processing SiC material of the present invention, it is possible to allow a crack to progress between respective lines reliably while shortening a laser beam irradiation time.

### BRIEF DESCRIPTION OF DRAWINGS

FIG. 1 is a schematic perspective view for describing a SiC material illustrating an embodiment of the present invention.

FIG. 2 is a schematic view for describing a laser irradiation apparatus.

FIG. 3 is a partial plan view of a SiC material illustrating an altered region forming portion.

FIG. 4 illustrates a modified example and is a partial plan view of a SiC material illustrating an altered region forming portion.

FIG. 5 illustrates a modified example and is a partial plan view of a SiC material illustrating an altered region forming portion.

### MODE FOR CARRYING OUT THE INVENTION

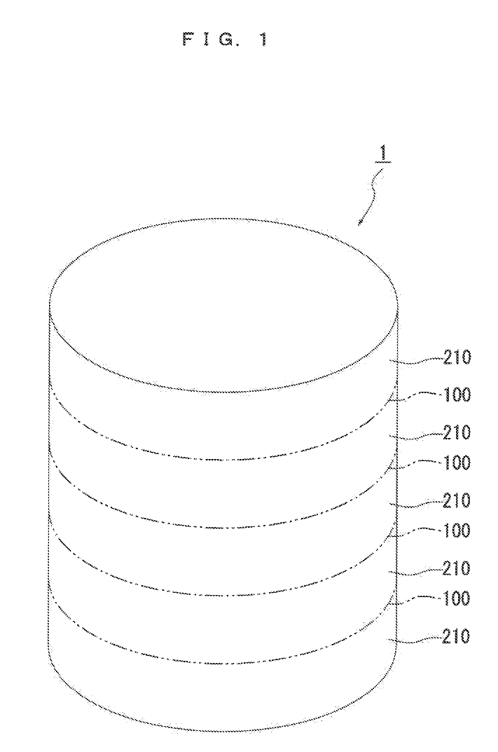

FIGS. 1 to 3 illustrate an embodiment of the present invention and FIG. 1 is a schematic perspective view for describing a SiC material.

As illustrated in FIG. 1, a SiC material 1 is formed in a cylindrical aim and is divided into a plurality of SiC substrates 210 by being cut at predetermined cutting scheduled planes 100. In the present embodiment, the SiC material 1 is formed of 6H-SiC and the diameter thereof may be 3 inches, for example. Moreover, the divided SiC substrates 210 are used as substrates of semiconductor device, for example.

Here, the respective cutting scheduled planes 100 are at an angle corresponding to an off-angle with respect to the c-plane orthogonal to the c-axis of the 6H-SiC. Therefore, by cutting the SiC material 1 along the cutting scheduled plane 100, it is possible to manufacture the SiC substrate 210 having a circumferential surface that is at an angle corresponding to the off-angle with respect to the c-plane. The off-angle is approximately 4°, for example, and may be 0°. When the off-angle is 0°, the interface is parallel to the c-plane.

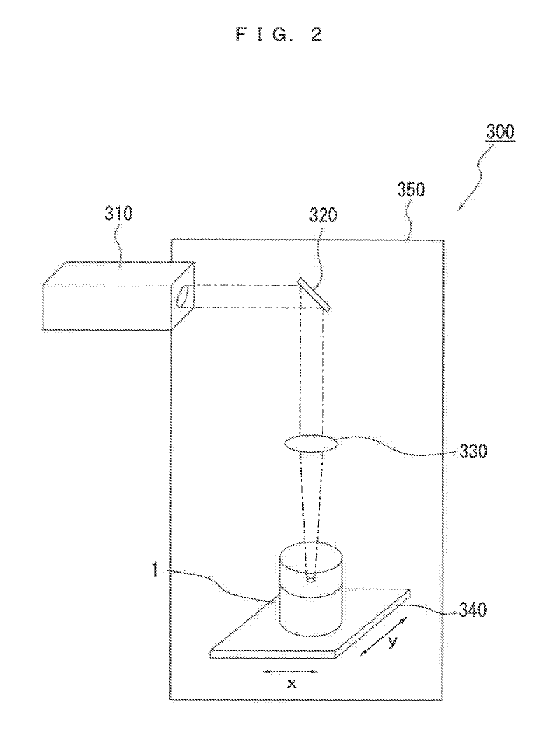

FIG. 2 is a schematic view for describing a laser irradiation apparatus.

As illustrated in FIG. 2, a laser irradiation apparatus 300 includes a laser oscillator 310 that oscillates a pulsed laser beam, a mirror 320 that changes the direction of the oscillated laser beam, an optical lens 330 that focuses the laser beam, and a stage 340 that supports a SiC stack 1 which is an irradiation target of the laser beam. Although a specific optical system is not illustrated particularly in FIG. 2, the laser irradiation apparatus 300 can adjust a focal position, adjust a beam shape, and correct an aberration, for example. Moreover, the laser irradiation apparatus 300 has a housing 350 that maintains the path of the laser beam in a vacuum state. In the present embodiment, a laser beam is irradiated to the SiC material 1 formed of 6H-SiC using the laser irradiation apparatus 300 to form an altered region inside the laser beam to cut the SiC material 1.

The laser oscillator 310 can use second-order harmonics of a YAG laser. A beam emitted from the laser oscillator 310 is reflected by the mirror 320 whereby the direction is changed. A plurality of mirrors 320 is provided to change the direction of the laser beam. Moreover, the optical lens 330 is positioned above the stage 340 to focus the laser beam incident on the SiC material 1.

The stage 340 moves in x and/or y-directions with the aid of a moving mechanism (not illustrated) to move the SiC material 1 placed thereon. Furthermore, the stage 340 may rotate about the z-axis. That is, it is possible to move the SiC material 1 in relation to the laser beam. In this way, it is possible to form a surface machined by the laser beam at a predetermined depth of the SiC material 1.

The laser beam is absorbed at a portion inside the SiC material 1 particularly near the focusing point. As a result, an altered region is formed in the SiC material 1. In the present embodiment, the laser beam is moved in relation to the SiC material 1 along a predetermined line in a state in which the focusing point is aligned at the respective cutting scheduled planes 100 inside the SiC material 1 whereby an altered pattern formed of a plurality of line-shaped altered regions is formed in the respective cutting scheduled planes 100. The direction in which the laser beam is moved in relation to the SiC material is not limited to a line shape hut may be moved in a curve shape.

In the present embodiment, one shot of pulse is irradiated at predetermined intervals along the respective cutting scheduled planes 100 to form a line-shaped altered region. A machined spot is formed in a portion irradiated with one shot of pulse, and an example of such a machined spot includes a crack spot, a molten spot, a refractive index-altered spot, or a spot in which at least two of these spots are mixed.

When the SiC material 1 is cut, first, a focusing point of the laser beam is aligned on the cutting scheduled plane 100 on one end side in the axial direction positioned close to an incidence side of the laser beam so that the laser beam is absorbed. in the cutting scheduled plane 100 to form an altered pattern. In this case, it is preferable to polish an incidence-side surface of the SiC material 1 so that incidence of the laser beam on the SiC material 1 is not interrupted.

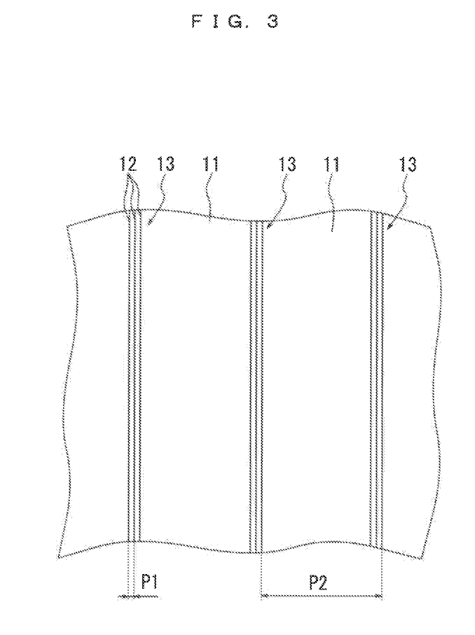

FIG. 3 is a partial plan view of a SiC material illustrating an altered region forming portion. As illustrated in FIG. 3, a focusing point of the laser beam is moved linearly to form a main altered region 12 that forms an altered pattern. The main altered region 12 is formed as a set of altered spots formed by one shot of pulse since the laser beam is a pulsed laser beam. Specifically, altered spots are formed continuously so that adjacent altered spots overlap partially with each other whereby respective line-shaped altered regions 12 are formed. The width of each altered region 12 is smaller than 1.0 μm and may be 0.2 μm, for example.

Specifically, as illustrated in FIG. 3, a plurality of line-shaped main altered regions 12 extending in a predetermined direction is formed at a first pitch P1 to form an altered region group 13 extending in the predetermined direction. Moreover, a plurality of altered region groups 13 is formed at a second pitch P2 larger than the first pitch P1. When the main altered region 12 is formed in this manner, it is possible to allow a c-plane crack to progress using a small number of main altered regions as compared to when the main altered regions 12 are arranged at equal intervals. Although the dimensions of the first and second pitches P1 and P2 are arbitrary, the first pitch P1 may be equal to or larger than 1 μm and smaller than 50 μm, for example, and the second pitch P2 may be equal to or larger than 50 μm and equal to or smaller than 500 μm, for example. Although the number of main altered regions 12 included in one altered region group 13 is arbitrary, the number may be equal to or larger than 2 and equal to or smaller than 10, for example.

Here, when the SiC material 1 is processed, the respective main altered regions 12 are sequentially formed unless all main altered regions 12 are formed simultaneously. In this case, it is preferable to prevent a c-plane crack from progressing in a forming scheduled portion of a predetermined main altered region 12 as a result of forming of another main altered region 12 before the predetermined main altered region 12 is formed. If the c-plane crack progresses before laser processing is performed, it is difficult to align the focal point of laser at the depth of the cutting scheduled plane 100 and the processing accuracy decreases.

After the respective main altered regions 12 are formed in the cutting scheduled plane 100, the other end side in the axial direction of the SiC material 1 is fixed and force is applied in a direction from the other end side in the axial direction toward one end side in the axial direction whereby the SiC material 1 is cut. After the SiC material 1 is separated, it is preferable to planarize the surface of the separated substrate 210 and a new surface of the SiC material 1 by polishing or the like. Particularly, when the cutting scheduled plane 100 is not parallel to the c-plane, since the separation surface is rough, it is more preferable to planarize the separation surface.

After that, the main altered region 12 is formed in the cutting scheduled plane 100 on one end side in the axial direction of the SiC material 1 from which the substrate 210 is separated, and the SiC material 1 is cut. In this manner, the SiC material 1 is sequentially cut from the other end side of all cutting scheduled planes 100 whereby a plurality of SiC substrates 210 is obtained.

According to the above-described method for processing the SiC material 1, since the second pitch P2 of the respective altered region groups 13 is relatively large, it is possible to shorten the laser beam irradiation time during processing of the cutting scheduled plane 100.

Since the c-plane crack is made easy to progress, it is possible to reduce the power of laser for forming the altered regions and to reduce processing damage per one altered region. In this way, no excessive processing damage is applied to a region other than the cutting scheduled plane 100 in relation to the depth direction of the SiC material 1, the processing damage near the cutting scheduled plane 100 can be suppressed as much as possible, and the laser processing controllability is improved. Furthermore, since the altered region group 13 includes a plurality of main altered regions 12, it is possible to apply stress to the SiC material 1, the stress having a value relatively close to a threshold stress at which a c-plane crack occurs in the SiC material 1. In this way, the laser processing controllability is also improved.

The main altered region 12 may have a curve shape other than the line shape as illustrated in FIG. 3. For example, the main altered region may be formed in a spiral form or may be formed in a concentric form at a predetermined interval. In this case, the pitch of the main altered regions adjacent in the radial direction may be changed to a first pitch that is relatively short and a second pitch that is relatively long.

In the embodiment, although the main altered regions 13 are formed at the first and second pitches P1 and P2, the main altered regions may be formed at three or more pitches. In this case, it is sufficient that the main altered regions 13 are formed at least at two pitches.

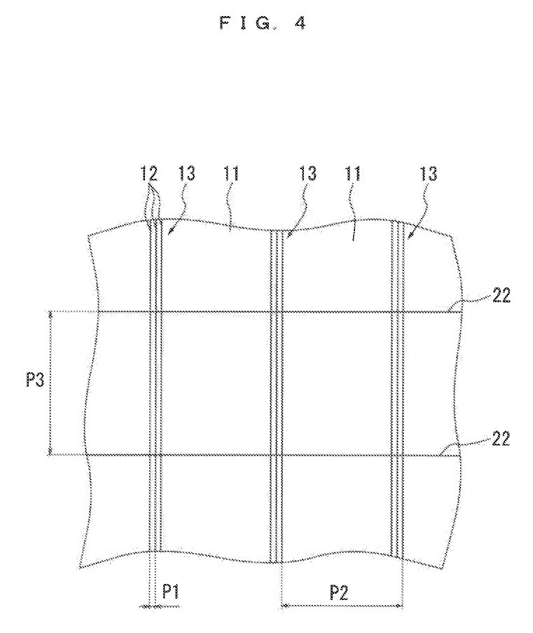

In the embodiment, although a plurality of main altered regions 12 extending in the same direction are formed, a plurality of line-shaped auxiliary altered regions 22 extending in a different direction from the main altered region 12 may be formed as illustrated in FIG. 4, for example. When the respective auxiliary altered regions 22 are formed so as to cross at least adjacent two altered region groups 13, it is possible to effectively allow a crack to progress in a region surrounded by each altered region group 13 and each auxiliary altered region 22. Moreover, as illustrated in FIG. 4, the auxiliary altered regions 22 are preferably formed so as to extend in a direction approximately orthogonal to the main altered regions 12. In this case, a third pitch P3 of the auxiliary altered regions 22 may be larger than the second pitch P2 of the altered region groups 13. When the main altered regions extend in a circumferential direction like a spiral form or a concentric form, the auxiliary altered regions are preferably formed so as to extend in a radial direction.

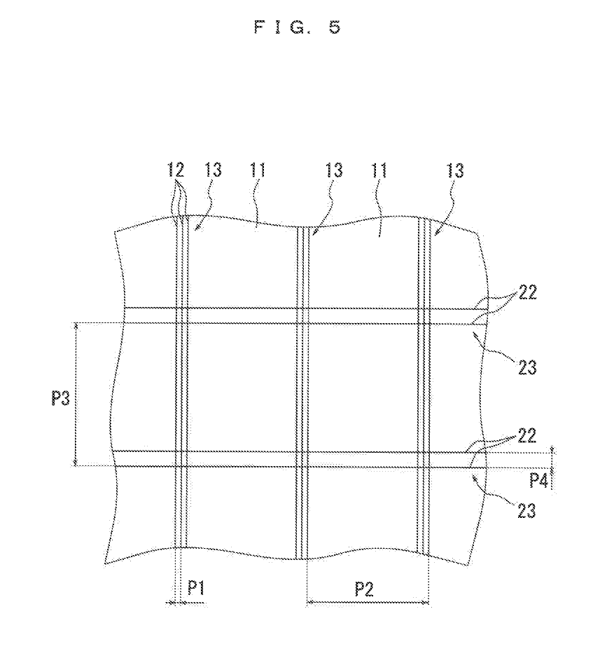

As illustrated in FIG. 5, a plurality of line-shaped auxiliary altered regions 22 may be formed at a fourth pitch P4 that is relatively short to form auxiliary altered region groups 23, and a plurality of auxiliary altered region groups 23 may be formed at the third pitch P3 larger than the fourth pitch P3. In this case, the third pitch P3 of the auxiliary altered regions 22 may be larger than the first pitch P1 of the main altered regions 12, and the fourth pitch P4 of the auxiliary altered region groups 23 may be larger than the second pitch P2 of the altered region groups 13. Moreover, although the number of auxiliary altered regions 22 included in one auxiliary altered region group 23 is arbitrary, the number may be equal to or larger than 2 and equal to or smaller than 10, for example.

As illustrated in FIGS. 4 and 5, even when the auxiliary altered regions 22 are formed as well as the main altered regions 12, the main altered regions 12 and the auxiliary altered regions 22 are sequentially formed unless all main altered regions 12 and all auxiliary altered regions 22 are formed simultaneously. In this case, it is preferable to prevent a c-plane crack from progressing in a forming scheduled portion of a predetermined main altered region 12 or a predetermined auxiliary altered region 22 as a result of forming of another main altered region 12 or another auxiliary altered region 22 before the predetermined main altered region 12 or the predetermined auxiliary altered region 22 is formed.

In the embodiment, although the present invention is applied to the SiC material 1 formed of 6H-SiC, the present invention can be applied to other poly SiC materials such as 3C-SiC or 4H-SiC, for example. Furthermore, the present invention can be applied to materials other than SiC in which a progress direction of cracks in the material is approximately parallel to a cutting scheduled plane. Examples of such materials include GaN, AlN, ZnO, and the like. In the present embodiment, although a plane orientation in which a progress direction of cracks in the material is approximately parallel to a cutting scheduled plane is the c-plane, the plane orientation may be the m-plane or the a-plane.

Although the embodiment of the present invention has been described above, the invention according to the claims is not limited to the above-mentioned embodiment. Moreover, it should be noted that all combinations of the features described in the embodiment are not essential for solving the problem of the invention.

### INDUSTRIAL APPLICABILITY

As described above, the method for processing SiC material according to the present invention is industrially useful in that it is possible to allow a crack to progress between respective lines reliably while shortening a laser beam irradiation time.

### REFERENCE SIGNS LIST

1: SiC material

11: Non-altered region

12: Main altered region

13: Altered region group

22: Auxiliary altered region

23: Auxiliary altered region group

100: Cutting scheduled plane

210: SiC substrate

300: Laser irradiation apparatus

310: Laser oscillator

320: Mirror

330: Optical lens

340: Stage

350: Housing

1. A method for processing SiC material, including:
allowing a laser beam to be absorbed in a cutting scheduled plane of an SiC material to form an altered pattern including a plurality of line-shaped altered regions; and
cutting the SiC material along the cutting scheduled plane,
wherein the altered pattern has altered region groups including a plurality of line-shaped main altered regions extending in a predetermined direction and arranged at a first pitch, and
a plurality of altered region groups is arranged at a second pitch larger than the first pitch.

2. The method for processing SiC material according to claim 1, wherein the altered pattern includes a plurality of line-shaped auxiliary altered regions extending in a different direction from the predetermined direction, and
the auxiliary altered region is formed so as to cross at least adjacent two altered region groups.

3. The method for processing SiC material according to claim 2, wherein the respective auxiliary altered regions extend in a direction approximately orthogonal to the altered region group.

4. The method for processing SiC material according to claim 1, wherein the number of main altered regions included in one altered region group is equal to or larger than 2 and equal to smaller than 10.

5. The method for processing SiC material according to claim 1, wherein the first pitch is equal to or larger than 1.0 μm and smaller than 50 μm, and
the second pitch is equal to or larger than 50 μm and equal to smaller than 500 μm.

6. A method for processing SiC material including:
allowing a laser beam to be absorbed in a cutting scheduled plane of an SiC material to form an altered pattern including a plurality of line-shaped altered regions; and
cutting the SiC material along the cutting scheduled plane,
wherein the altered pattern has a plurality of line-shaped main altered regions extending in a predetermined direction, and
pitches between the respective main altered regions include at least two pitches.
